(19) United States
(12) Patent Application Publication
(10) Pub. No.: US 2024/0429778 A1
(43) Pub. Date: Dec. 26, 2024

(54) FLYWHEEL BATTERY

(71) Applicant: MALEX EUROPE S.R.L., Guardiagrele (IT)

(72) Inventor: Marco BUFIS, Francavilla al Mare (IT)

(21) Appl. No.: 18/274,039

(22) PCT Filed: Feb. 14, 2022
(86) PCT No.: PCT/IB2022/051274

§ 371 Date: Jul. 25, 2023

(30) Foreign Application Priority Data
Feb. 15, 2021 (IT) 102021000003314

(51) Int. Cl. H02K 7/02

(52) U.S. Cl. CPC H02K 7/025

(57) ABSTRACT

Flywheel battery comprising at least one rotor (13) mechanically connected to at least one flywheel (26) through at least one central shaft (20) suitable to rotate around a central axis (A), wherein the central shaft (20) is joined to one or more supports (23) comprising at least one hub in which at least one secondary shaft (24) can rotate, wherein one or more flywheels (26) are mechanically connected to the secondary shaft (24) to rotate around the central axis (A) and around an axis substantially parallel to the central axis (A) by means of a transmission (27, 28).

### TECHNICAL FIELD

The present description relates to a flywheel battery, in particular a flywheel battery which can be used for example in vehicles and electric power generators.

### BACKGROUND OF THE DESCRIPTION

Known flywheel batteries comprise a flywheel connected to a rotor coupled to a stator in order to transform electrical energy, namely an electrical current in the stator, into the rotation of the flywheel, and vice versa.

However, the mass, the diameter and/or the speed of the flywheel must be increased to increase the capacity of known flywheel batteries, with consequent problems of weight, footprint and/or gyroscopic effect, which reduce their safety, efficiency, portability and/or economic convenience.

U.S. Pat. Nos. 4,128,020 and 10,900,540 disclose known flywheel batteries.

### SUMMARY OF THE DESCRIPTION

The object of the present description is therefore to provide a flywheel battery free from such drawbacks. Said object is achieved with a flywheel battery, the main features of which are specified in the attached claims, to be considered an integral part of the present description.

Thanks to the particular combination of flywheels which rotate like satellites around a central shaft, the flywheel battery according to the present description maximizes the accumulation of energy per unit of mass, so as to limit the weight, the production, maintenance and disposal costs, the deterioration over time, the gyroscopic effect and the risk of accidents compared to the known flywheel batteries.

In particular, if Ec1 represents the component of kinetic energy due to the masses m of the n flywheels in a circular motion of radius R with angular velocity ω of the central shaft and Ec2 represents the kinetic energy stored by the set of n flywheels per rotation around their own axis with angular velocity ω′, where J represents the moment of inertia around this axis of the single flywheel, the energy that can be accumulated by the present flywheel battery is therefore given by the equation Ec=Ec1+Ec2 where Ec1=(n*m*R*ω²)/2 and Ec2=(n*w′²*J)/2.

The above equation shows that the increase in accumulated energy and therefore the charge density is greater than in a battery with a flywheel keyed to the central shaft, whose accumulated energy is only Ec=(ω²*J)/2.

Preferably, in the present flywheel battery the flywheels rotate around their axis thanks to a transmission comprising a ring gear with an inner gearing fixed in a vacuum chamber containing the flywheels and pinions keyed on the secondary shafts of the flywheels. Thus, the kinetic energy of the system of flywheels and supports is increased as a function of the ratio of the angular velocities of the central shaft and of the secondary shafts, so that the energy stored by the flywheel battery will be determined by the sum of the kinetic energy obtained from these two angular velocities.

Once the flywheels are placed in rotation, the flywheel battery keeps kinetic energy thanks to the minimalization of dispersions and friction, in particular the friction due to the fluid in which the rotating system is immersed, which is arranged inside a particular vacuum chamber.

The flywheel battery preferably comprises one or two stators which can be moved towards or away from the respective rotors, so as to avoid the braking effect of the stators when they are not in use.

### BRIEF DESCRIPTION OF THE DRAWINGS

Further advantages and features of the flywheel battery according to the present description will become evident to those skilled in the art from the following detailed description of some embodiments, to be considered as non-limiting examples of the claims, with reference to the attached drawings in which:

FIG. 1 is an isometric view of the flywheel battery;

FIG. 2 is an isometric view of the interior of the flywheel battery;

FIG. 3 is a front view of the flywheel battery;

FIG. 4 is section IV-IV of FIG. 3;

FIG. 5 is section V-V of FIG. 3;

FIG. 6 is an exploded view of the flywheel battery.

### EXEMPLARY EMBODIMENTS

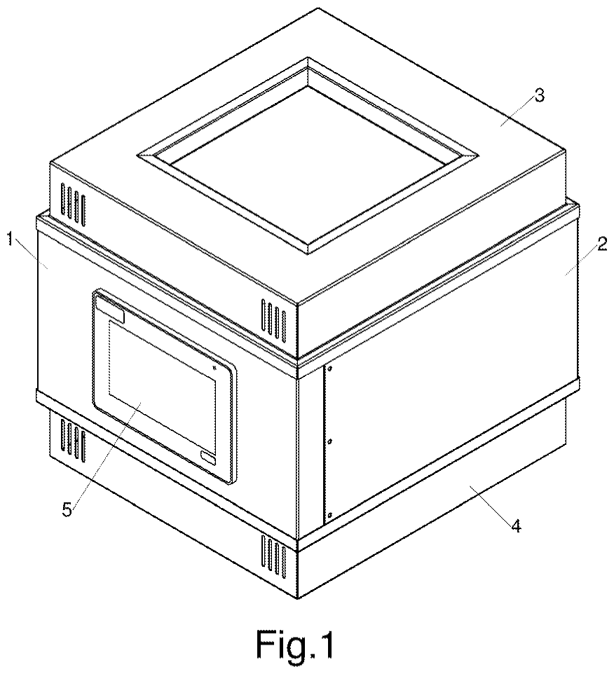

FIG. 1 shows an embodiment of the flywheel battery, which can be provided with a container which has a substantially rectangular parallelepiped shape and comprises for example two side covers 1, 2, both with two substantially perpendicular walls, an upper cover 3 and a lower cover 4. Covers 1-4 can be made of metal sheet to protect the internal parts from shocks, dust, liquids or flames, as well as shielding from external electromagnetic fields, acting as a Faraday cage. The side cover 1 can comprise electronic control means, in particular a control unit 5 provided with a touchscreen.

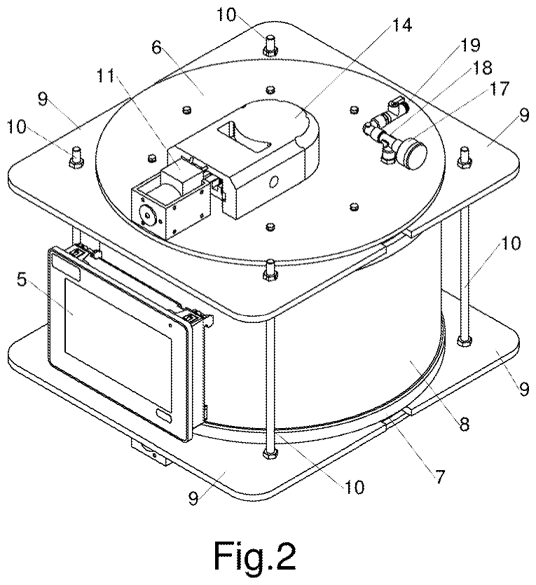

FIG. 2 shows that the container 1-4 includes a vacuum chamber which comprises for example an upper base 6, a lower base 7 and at least one side wall 8, which are hermetically joined together by a plurality of brackets 9 and tie rods 10. The vacuum chamber 6-8 preferably has a substantially cylindrical shape.

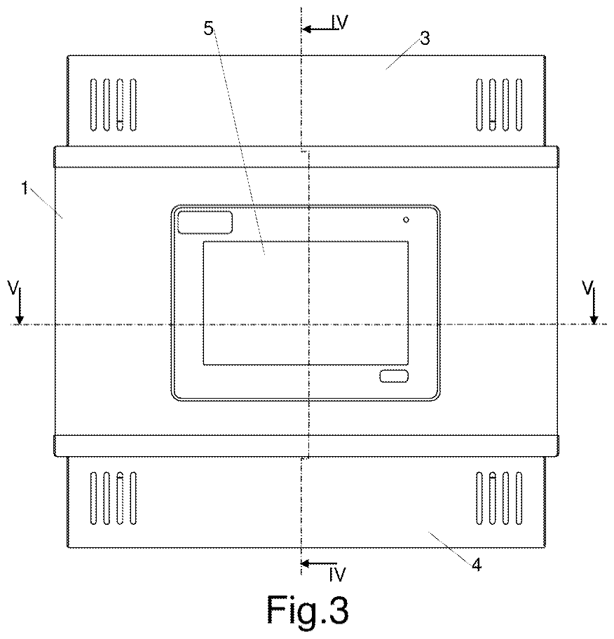

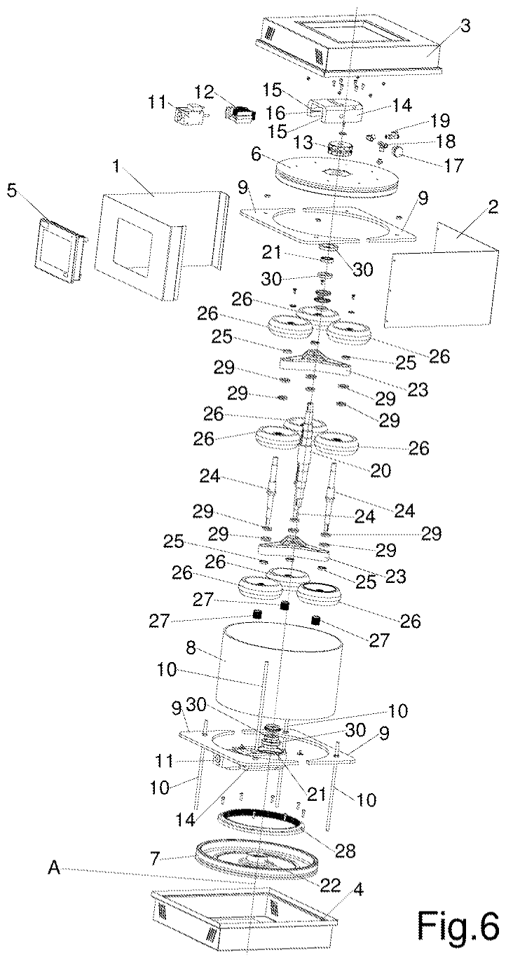

FIGS. 3 to 6 show that at least one actuator 11, preferably electromagnetic, is arranged outside the vacuum chamber 6-8, for example on the upper base 6, to move at least one coil 12 acting as a stator, towards or from at least a rotor 13, which is provided with a plurality of magnets, in particular sixteen permanent magnets, with the N-S polarities oriented radially with respect to the axis of the rotor 13 and alternately with respect to the adjacent magnets.

The rotor 13 is arranged in at least one housing 14 hermetically fixed on the upper base 6 of the vacuum chamber 6-8 and in fluid connection with the interior of the latter, so that vacuum is also present in the housing 14.

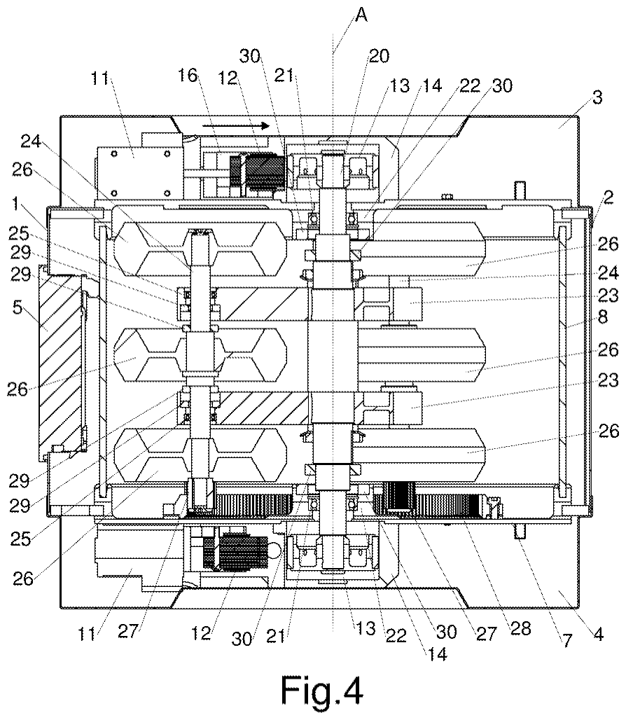

In a charging phase of the flywheel battery, namely transformation of electrical energy into kinetic energy, the actuator 11 moves the stator 12, in particular by translating it in the direction of the arrow of FIG. 4, towards the rotor 13, preferably along guides 15 obtained in a seat 16 arranged outside the housing 14 of the rotor 13. The stator 12 can therefore be arranged beside the rotor 13, while remaining outside the vacuum chamber 6-8, and an external source (not shown in the figures) can supply electric current to the stator 12 to rotate the rotor 13, in particular by generating a rotating magnetic field. The actuator 11 moves the stator 12 away from the rotor 13 when the flow of electric current in the stator 12 is interrupted.

The housing 14 is preferably made of diamagnetic material in order not to generate dispersions due to the rotation of the magnets of the rotor 13. The vacuum chamber 6-8 can be provided with a vacuum gauge 17 fixed to the outside of the upper base 6 to measure the level of the vacuum in the vacuum chamber 6-8. The vacuum can be created by means of a pump connected to a duct 18 which opens into an opening in the vacuum chamber 6-8 and is provided with a valve 19 arranged in parallel with the vacuum gauge 17.

The rotor 13 is mechanically connected, in particular keyed, to a central shaft 20 which can rotate around a central axis A in the vacuum chamber 6-8, in particular by means of bearings 21 arranged in hubs 22 fixed to the upper base 6 and/or at the lower base 7, which bases have central openings so that one or both ends of the central shaft 20 can protrude beyond the vacuum chamber 6-8, in particular into the housing 14. The central axis A can be substantially coaxial to the longitudinal axis of the vacuum chamber 6-8.

One or more supports 23 are joined to the central shaft 20 and are arranged in the vacuum chamber 6-8. In particular, at least two supports 23 comprising at least three radial arms are keyed around the central shaft 20. One or more supports 23 comprise at least one hub, preferably arranged at one end of each radial arm, in which a secondary shaft 24 can rotate by means of one or more bearings 25. The axis of the secondary shaft 24 is substantially parallel to the central axis A. One or more flywheels 26 are mechanically connected, in particular keyed, to each secondary shaft 24. In particular, at least three flywheels 26 they are keyed to a secondary shaft 24, in which a support 23 is arranged between two flywheels 26.

Further embodiments may include different numbers of supports 23, secondary shafts 24 and/or flywheels 26.

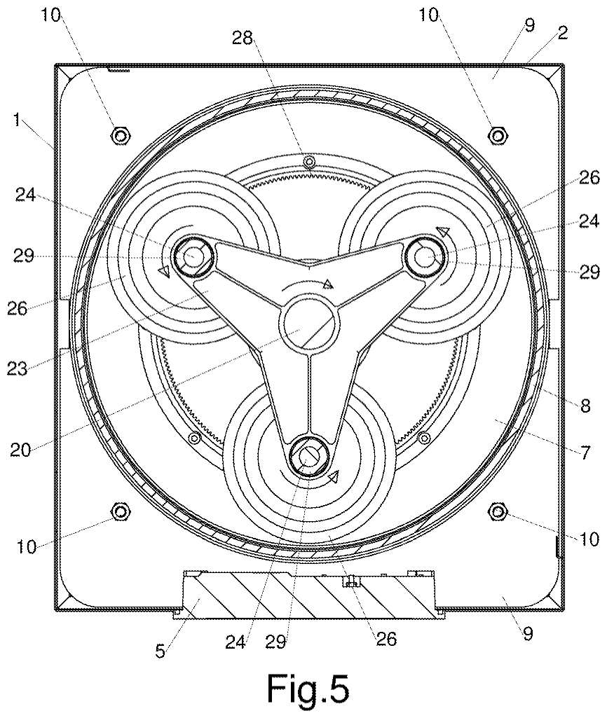

At least one end of each secondary shaft 24 is provided with at least one pinion 27 which is meshed with at least one ring gear 28, preferably having an internal gearing, so that when the central shaft 20 rotates in one direction (for example clockwise as shown in FIG. 5), the flywheels 26 rotate both around the central axis A and around the respective longitudinal axis in the opposite direction (for example counterclockwise as shown in FIG. 5), thanks to the transmission comprising the pinions 27 and the ring gear 28.

Further embodiments may include transmissions, for example magnetic and/or mechanical, which are different from the gear 27-28 for rotating the flywheels 26 around their axis.

Preferably, the ring gear 28 is joined to the lower base 7 of the vacuum chamber 6-8 and the pinions 27 are arranged at the end of the secondary shafts 24 facing the lower base 7. Magnetic rings 29, 30 with opposite polarities can be arranged around the central shaft 20 and/or the secondary shafts 24, respectively, to reduce friction with the hubs 22 and/or the supports 23.

A further actuator 11 can be arranged outside the vacuum chamber 6-8, for example under the lower base 7, to move a further coil 12 acting as a stator, towards or from a further rotor 13 arranged in a further housing 14 hermetically fixed under the lower base 7. The further rotor 13 is mechanically connected, in particular keyed, to the end of the central shaft 20 opposite the end provided with the first rotor 13. The further stator 12 can act as a generator of electric current induced by the rotation of the further rotor 13, under the control of the control unit 5, when the stator 12 is moved close to the rotor 13 by the actuator 11.

The pairs of actuators 11, stators 12, rotors 13 and/or housings 14 can be substantially identical to each other or different according to the electrical specifications of the flywheel battery.

In use, a given speed ratio directly proportional to the ratio of the teeth of the pinions 27 and of the ring gear 28 corresponds to a rotation of the central shaft 20 with the supports 23, so that the angular velocity of the flywheels 26 increases proportionally to the angular velocity of the central shaft 20, and vice versa.

Variations or additions can be made by those skilled in the art to the embodiments herein described and illustrated while remaining within the scope of the following claims. In particular, further embodiments may comprise the technical features of one of the following claims with the addition of one or more technical features described in the text or illustrated in the drawings, taken individually or in any mutual combination.

1. Flywheel battery comprising at least one rotor mechanically connected to at least one flywheel through at least one central shaft suitable to rotate around a central axis, wherein the central shaft is joined to one or more supports comprising at least one hub in which at least one secondary shaft can rotate, wherein one or more flywheels are mechanically connected to the secondary shaft to rotate around the central axis and around an axis which is substantially parallel to the central axis and does not coincide with the central axis, by means of a transmission.

2. The flywheel battery according to claim 1, wherein the rotor is keyed to the central shaft and/or the flywheels are keyed to one or more secondary shafts.

3. The flywheel battery according to claim 1, wherein the supports comprise at least three radial arms having a hub arranged at one end of each radial arm, a secondary shaft being arranged in each hub.

4. The flywheel battery according to claim 1, wherein the central shaft comprises at least two supports, wherein a support is arranged between at least two flywheels arranged on at least one secondary shaft.

5. The flywheel battery according to claim 1, wherein the central shaft, the supports and the flywheels are arranged in a vacuum chamber which comprises an upper base, a lower base and at least one side wall.

6. The flywheel battery according to claim 5, wherein the at least one rotor is arranged in at least one housing hermetically fixed on the upper base and/or under the lower base of the vacuum chamber and in fluid connection with the inside of the latter.

7. The flywheel battery according to claim 6, wherein the at least one housing is made of diamagnetic material.

8. The flywheel battery according to claim 1, wherein at least one actuator is suitable to move at least one stator towards or from the at least one rotor to rotate the rotor and/or generate electric current in the stator.

9. The flywheel battery according to claim 1, wherein the at least one rotor is provided with a plurality of magnets with the N-S polarities oriented radially with respect to the axis of the rotor and alternately with respect to the adjacent magnets.

10. The flywheel battery according to claim 1, wherein said transmission is a magnetic and/or mechanical transmission suitable to rotate the flywheels around their axis in one direction when the central shaft rotates in the opposite direction around the central axis.

11. The flywheel battery according to claim 1, wherein said transmission comprises at least one pinion which is keyed to at least one secondary shaft and is meshed with at least one ring gear.

12. The flywheel battery according to claim 11, wherein the ring gear is fixed in a vacuum chamber containing the flywheels.

13. The flywheel battery according to claim 11, wherein the ring gear has an inner gearing in which the at least one pinion is engaged.

14. The flywheel battery according to claim 11, wherein a given speed ratio directly proportional to the ratio of the teeth of the pinions and of the ring gear corresponds to a rotation of the central shaft with the supports, so that the angular velocity of the flywheels increases proportionally to the angular velocity of the central shaft, and vice versa.

15. The flywheel battery according to claim 1, wherein magnetic rings with opposite polarities are arranged around the central shaft and/or at least one secondary shaft.
